(19) United States
(12) Patent Application Publication
(10) Pub. No.: US 2008/0141166 A1
(43) Pub. Date: Jun. 12, 2008

(54) USING IMAGES IN ALTERNATIVE NAVIGATION

(75) Inventors: Elad Goldberg, Ramat Hasharon (IL); Amit Tropper, Yokneam Illit (IL)

Correspondence Address: ABELMAN, FRAYNE & SCHWAB, 666 THIRD AVENUE, 10TH FLOOR, NEW YORK, NY, 10017, US

(73) Assignee: CISCO TECHNOLOGY, INC., San Jose, CA (US)

(21) Appl. No.: 11/609,031

(22) Filed: Dec. 11, 2006

(51) Int. Cl. G06F 3/048

(52) U.S. Cl. 715/788; 715/835

(57) ABSTRACT

Navigation of a hierarchical system is facilitated by a specialized graphical user interface in which graphical representations of different levels of the hierarchy are mapped to and coordinate with menu controls. The graphical representation may variously describe the topological arrangement of a hierarchy or a functional representation of a hierarchical system. Selecting an element of the graphical representation causes a new representation to appear, showing higher level of detail of the selected element. Simultaneously the menu controls expand to offer submenus corresponding to the greater detail for selection by a user. The graphical representation may be augmented by other controls, such as shortcut icons for enhanced performance.

### BACKGROUND OF THE INVENTION

1. Field of the Invention

This invention relates to management of computer networks. More particularly, this invention relates to a graphical user interface for visualizing and controlling a computer network.

2. Description of the Related Art

TABLE 1
Acronyms and Abbreviations

| | |
|---|---|
| AAA | Authentication, Authorization, and |
| | Accounting |
| CMTS | Cable Modem Termination System |
| GUI | Graphical User Interface |
| LAN | Local Area Network |
| MAP | Map Routing Technique |

A graphical user interface (GUI) is a computer terminal or monitor interface, based on graphics instead of text. A graphical representation appears on a display and a user can interact with the system using a selection device, for example a mouse. The management of a large computer system or network requires management of a large amount of data, which is typically organized hierarchically.

A graphical user interface for visualizing and controlling a hierarchic structure may consist of a first icon or set of icons that represents the structure at the top level. If a user activates the first icon with the selection device, e.g., by clicking on it, a second set of icons appears, representing a lower level of the structure. This may be repeated until the user sees an icon representing the component or function to be managed. The well-known Windows Explorer utility of Microsoft® Windows® is an example of such a graphical user interface

Alternatively, the graphical user interface may consist of menus and submenus representing the different devices and properties at different levels of the hierarchic structure. If a user activates the top-level menu, e.g., by clicking on it, a second level menu appears representing a lower level of the hierarchy. This may be repeated until the user sees a menu item representing the component or function to be managed.

Commonly assigned U.S. Pat. No. 6,628,304 to Mitchell, et al., which is herein incorporated by reference, discloses presenting hierarchical data to a user via a graphical user interface. In the interface, hierarchical data is represented by nodes, beginning with one or more top nodes and extending into lower hierarchical levels by the display of child nodes, grandchild nodes, etc. The arrangement of nodes on the graphical user interface is such that scaling portrays the various hierarchical levels, and nodes do not spatially interfere with one another. Navigation through the hierarchical data is provided by allowing the user to select any visible node, at which point a zoom-in or zoom-out view to the selected node as a centrally located node on the interface is performed. Child nodes at lower hierarchical levels that were not visible before selection are then made visible up to a predetermined number of levels within the hierarchy. A map is provided on the interface, which allows a user to graphically comprehend the present location of all nodes displayed on the interface in relation to their position within the overall hierarchy. As applied to network management, the interface allows errors in low level devices within a network to be visually propagated up to the upper levels of the hierarchy, for display to a user viewing only the top levels.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 schematically depicts in a simplified form a networked data communication system in which the techniques of the present invention may be implemented;

FIG. 2 is a flow chart illustrating a method of operation of a graphical user interface in accordance with a disclosed embodiment of the invention;

FIG. 3 is a screen display including in its content area a graphical representation of a network being managed, in accordance with a disclosed embodiment of the invention;

FIG. 4 shows another state of the screen display shown in FIG. 3, in accordance with a disclosed embodiment of the invention;

FIG. 5 shows a screen display, which includes a graphical representation of user configuration domains in a computer network, in accordance with a disclosed embodiment of the invention;

FIG. 6 shows a screen display that was produced in accordance with a disclosed embodiment of the invention;

FIG. 7 is a screen display showing a graphical representation of a computer network, in accordance with an alternate embodiment of the invention; and

FIG. 8 is a screen display similar to the screen display shown in FIG. 5, wherein some group icons have been augmented by shortcut icons in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client/server environment, such software programming code may be stored on a client or a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and distributing software code via networks are well-known and will not be further discussed herein.

### Overview.

In complex hierarchical representations there is little scalability to different levels of detail. When viewing a low level icon or menu, the user cannot see the hierarchic structure as a whole. It can be difficult to find a desired activity or data item. Once more than a few heavily populated folders or network segments are expanded via user selection, the user may become disoriented with respect to what area or location of the file system, network or other hierarchical data representation he is currently viewing. Furthermore, considerable navigation through the hierarchy can be required to reach a desired item or to perform certain activities.

The exemplary embodiments described below relate to a certain type of network scenario, which have been selected for conceptual clarity. However, the principles of the invention may be applied more broadly to many applications in which hierarchical data needs to be navigated. The techniques presented below are GUT navigation techniques that are complementary to conventional menu techniques, e.g., dropdown menus, trees, drawers.

In one field application of the invention, computer networks typically comprise a combination of computer systems interconnected with a number of network communications devices such as modems, hubs, routers, bridges, and switches. Such networks may be interconnected with other networks, such as those from government agencies, or other entities, to form a worldwide system of interconnected networks, such as the Internet. Such a computer network can be broken down logically into various hierarchical levels. For instance, a high speed fiberoptic link controlled by high speed routers might form a first level in a hierarchy. This top-level network may interconnect many smaller regional networks associated with specific buildings, cities, or geographical areas, each of which represents a second level in the network hierarchy. Each regional network may interconnect departmental networks representing a third level in the network hierarchy. Each departmental network may include many individual subnetworks of computers, terminals, printers, file and web servers, and so forth to form a fourth level of the hierarchy. Each computer and data communications device may then be considered on an individual basis as a fifth level in the hierarchy and may include various internal devices or peripherals, which form a sixth hierarchical level.

In order to assist a user faced with navigating a complex hierarchical system such as a computer network, a system-wide perspective is commonly obtained from user guides and help files. In the case of complex processes, programs known as “wizards” may lead administrators through a process and avoid navigation of the system in part or entirely. However, familiarity with such systems often must be achieved by gradually gained experience, which can be long and drawn-out. “Shortcuts”, toolbars and “hot keys” are interface features that can be installed or made available for use with a graphical user interface and which can eliminate some navigation. However, in normal use, they can easily become so numerous as to be unwieldy.

Modern graphical user interfaces typically have one or more navigation panels and content areas. A content area is an area of a displayed page or screen, in which the user enters data, reads information. Navigation panels are realized, for example by menu bars, tool bars, or controls, which when actuated, cause some operation to be executed, or cause the content in the content area to be changed.

In some embodiments of the invention, a graphical representation of a hierarchical network management system is displayed in the content area of a page. This representation may describe the topological arrangement of the network. Alternatively, the representation may be a functional representation of the system, indicating processes, or data flows of the system (such as packet processing). Alternatively, the representation could be oriented toward security features, indicating privileges at various levels of the hierarchy. Many other representations of the network will occur to those skilled in the network management art. Indeed, the graphical representation could describe many systems and data collections unrelated to network management.

In an aspect of the invention, a portion of the graphical representation is mapped to items in a simultaneously displayed menu. This mapping may be used to obtain help about the menu items. Additionally or alternatively, the mapping may serve as a convenient entry to a navigation path through the hierarchy via the menu.

Context-sensitive help relating to elements of the graphical representation may be immediately available, responsively to a selection device. For example, in one embodiment, when a mouse pointer passes across an element of the graphical representation that is mapped to a menu item, a visual indicator, e.g., a tooltip, appears on the display, containing a short description about the item. Meanwhile, the menu item is highlighted on the appropriate menu, thereby facilitating an appropriate selection by the user.

When a selection on the graphical representation is made by the user, e.g., by a mouse click, a corresponding menu item is coordinately opened automatically in the menu bar, showing its submenu (if such exists), or executing a designated operation. Additionally or alternatively, selection of an item in the graphical representation may enable a more detailed help display, e.g., a popup window.

Typically, the initial graphical representation of the system in the content area is a broad overview, mapped to a high level menu in the navigation panel. When an item of the high level menu is selected, either from the graphical representation or directly from the menu bar, e.g., by a “right-click” or single click of a mouse, a submenu is exposed, and the initial graphical representation in the content area is replaced by a more detailed graphical map that represents the items in the submenu. This process may iterate, focusing on progressively narrower, but more detailed graphical representations of submenus, eventually reaching the level of the leaves of the hierarchical tree, at which point the process ends, or reiterates at a higher level. Ancillary help displays in the content area or elsewhere may be presented at various stages during the user interaction.

In most cases, orientation and access to a desired object is gained more quickly by coordinately controlling the graphical representations and menus and submenus, and appropriately introducing help aids than by using conventional menus and help pages. The graphical representation may be tailored as a filter, so as to provide rapid access to a frequently accessed subset of options and entries that may be offered by the object. The user thereby avoids navigating through less frequently accessed items. When configured in this manner, the graphical representation complements the menus and submenus, which may be far more detailed in the case of a complex object.

An embodiment of the invention provides enhancements in an authentication, authorization, and accounting (AAA) server used in the operation of a computer network in which a processing unit is linked to a memory, the network, a terminal, and a selection device. The processing unit executes a computer program causing the terminal to display a hierarchical model of the computer network, in which first and second icons representing network data items are arranged in respective first and second hierarchical levels. A navigation panel is also displayed, which has first and second controls respectively mapped to the first and second icons. When a pointer is moved to one of the first icons, a corresponding first control of the navigation panel is emphasized. Selection of one of the first icons causes them to be replaced by the second icons, and the navigation panel is simultaneously modified to display the second controls. The process may be iterated to view any number of hierarchical levels.

### EMBODIMENT 1

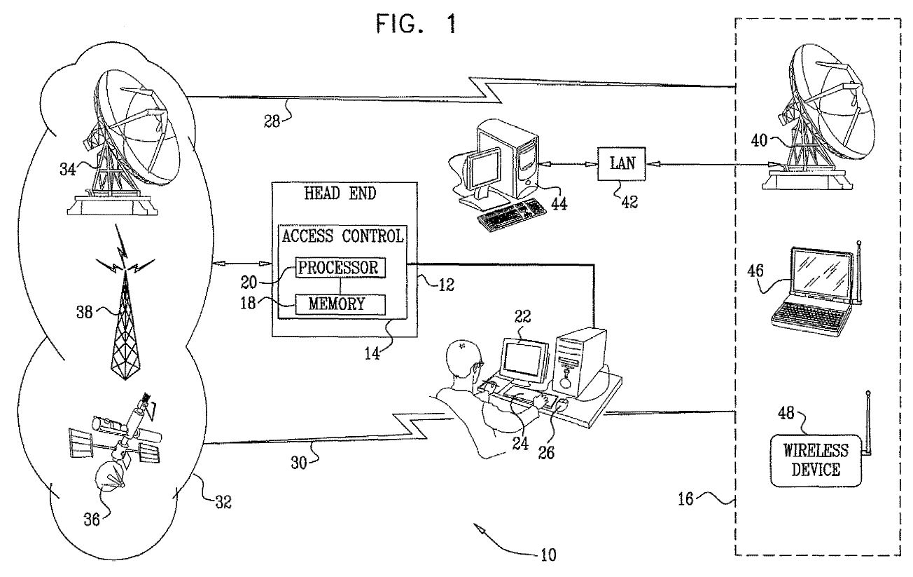

Turning now to the drawings, reference is initially made to FIG. 1, which schematically depicts a simplified version of a networked data communication system 10, in which the techniques of the present invention may be implemented. The system 10 is a useful example for explaining the principles of the invention. However, the principles of the invention can be practiced with many different network systems and data hierarchies. Indeed, the principles of the invention can be applied using a standalone computer. A wireless network is shown in FIG. 1 by way of example and not of limitation. In various embodiments, wireless links may be replaced in whole or in part by other known connections, in which case wireless network elements are replaced by other network elements. For example, in an optical network devices such as add-drop multiplexers, regenerators, digital cross-connects, and section terminating equipment may be substituted for wireless uplink and downlink channels.

The system 10 includes a head end 12 (also known as a central termination unit). The head end 12 includes an AAA server 14, which communicates with a plurality of nodes 16, and coordinates access between each of the nodes 16 and the head end 12. In some embodiments, the head end 12 communicates with network devices in a network environment, gathering information on network elements through the use of a network management protocol that remotely queries the network devices and, in turn, the network devices provide status information. The AAA server 14 may include a memory 18 and at least one processor 20.

Typically, a supervisory operator interacts with the AAA server 14 using a display 22, which may be realized as any suitably linked computer device or workstation having a suitable input device such as a keyboard 24, and a graphical selection device, such as a mouse 26. While a direct connection is shown between the AAA server 14 and the display 22, the AAA server 14 may communicate with other network elements using downlink channels 28 and uplink channels 30.

In FIG. 1 wireless links comprising one or more downlink channels 28 and one or more uplink channels 30 between the head end 12 and the nodes 16 via any one of a plurality of wireless transmitting and receiving devices 32, shown as a satellite base station 34, an orbital satellite 36, and a radio tower 38.

The nodes 16 may include any one of a number of wireless transmitting and receiving devices. For example, a satellite dish 40 may be used to communicate with the head end 12 via the downlink channels 28 and the uplink channels 30. The satellite dish 40 may, in turn, be connected to a local area network 42 (LAN), which, may be further connected to one or more computer systems 44. Another wireless device may be a portable wireless computer system 46, which is able to transmit and receive information to the head end 12 via the downlink channels 28 and the uplink channels 30. Other devices 48 may include, for example, wireless telephones, handheld computing devices, etc.

The downlink channels 28 and the uplink channels 30 may be utilized in a manner similar to that of the upstream and downstream channels of a cable modem network. Thus, with the aid of the network management navigation aids disclosed in detail herein below, Cable modem termination system domain assignment and Map Routing Techniques (MAP) may easily be implemented in the system 10, as taught, for example, by commonly assigned U.S. Pat. No. 7,085,287, which is herein incorporated by reference. Moreover, the techniques of the present invention may be easily implemented in any computer network, which uses shared access channels for communicating between a centralized computing system and one or more remote nodes.

### Operation.

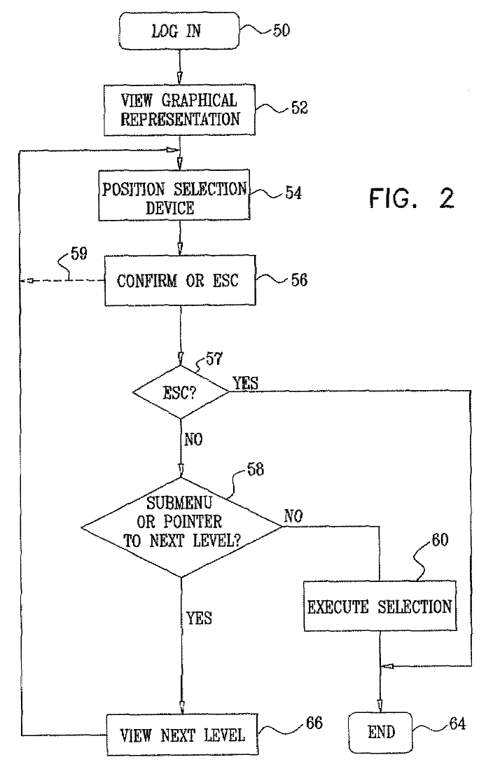

Reference is now made to FIG. 2, which is a flow chart illustrating a method of operation of a graphical user interface in accordance with a disclosed embodiment of the invention. In one embodiment, the operations described below can be performed on pages of a document written in a markup language, e.g., HTML, and presented on the display 22 (FIG. 1) using a conventional browser. The operations can be implemented by incorporating suitable HTML directives and instructions within the document. The method is performed iteratively, and for convenience is explained with reference to screen displays, which usually show a first iteration of respective steps. It will be understood that whenever desired, the user may cancel a currently represented level of the system hierarchy, e.g., by pressing the “Esc” key of a keyboard. While FIG. 2 is explained with respect to a network management application, this is exemplary, and the method can be performed with many other applications employing a GUI.

At initial step 50 a user logs into an access control system management application. The application is suitable for controlling the network using the AAA server 14 (FIG. 1).

Next, at step 52, the user is presented with a graphical representation of the current level of the system hierarchy. In the first iteration, this is a top-level view. A menu bar or navigation panel is also presented.

Next, at step 54, the user points or moves a graphical selection device, e.g., a mouse, over an area of the image. When the mouse pointer (or the indicator of another conventional selection device) is proximate to an icon of the graphical representation, the corresponding mapped element of the menu bar is automatically emphasized, e.g., by highlighting. A tooltip may also appear near the icon.

Next, at step 56, the area indicated at step 54 is confirmed by actuating the selection device, e.g., by clicking a mouse, on an icon of the graphical representation, pressing an appropriate key of a keyboard, or making a selection from the currently emphasized menu. Optionally, the user may choose to disregard the currently indicated area, and simply move the selection device to another area. This possibility is indicated by the broken line 59 leading from step 56. In some embodiments, the selection could be confirmed simply by leaving the mouse in place for a predetermined time period. However, in the event the user determines that the current display level or submenu is inappropriate to his requirements, an escape sequence can be initiated at this time, e.g., by pressing the “Esc” key on the keyboard.

Control now proceeds to decision step 57, where it is determined if an escape sequence was initiated. If the determination at decision step 57 is affirmative, then control proceeds to final step 64 and the process ends.

If the determination at decision step 57 is negative, then control proceeds to decision step 58, where it is determined if the item selected in step 56 is an icon referring to a higher level of detail in the graphical display or equivalently is a corresponding submenu item if the selection in step 56 was made using the currently emphasized menu.

If the determination at decision step 58 is negative, then it is concluded that the selected item was a terminal element in the hierarchy represented by the menu system and the graphical display. No further navigation of the menu system or graphical display occurs, because the selection corresponds to a definitive action to be taken, e.g., a command, program to be executed, or content to be displayed. Control proceeds to step 60 and the selection is executed. In the content area of the screen display, appropriate information representing the selected activity or function may now appear and optionally replaces the graphical representation. The procedure then terminates at final step 64.

If the determination at decision step 58 is affirmative, then control proceeds to step 66. An appropriate element of the menu expands to show a submenu, and a new graphical representation showing a higher level of detail of the previously selected item appears. This higher level of detail corresponds to the submenu.

Control returns to step 54 to begin another iteration. While not shown explicitly in FIG. 2, it will be understood that the user may return to a higher level of the system hierarchy at any time, for example, by use of the browser's “back” control. Additionally or alternatively, return to a higher level may be effected by clicking a higher entry bar of the menu, or by clicking an icon indicating a return to a higher hierarchical level in the graphical representation.

### Example.

This example describes a series of screen displays that were developed by performing the method disclosed above with respect to FIG. 2 on a prototype embodiment. The computer application that was executed is a network access control management application, which is adapted to management of systems such as the system 10 (FIG. 1).

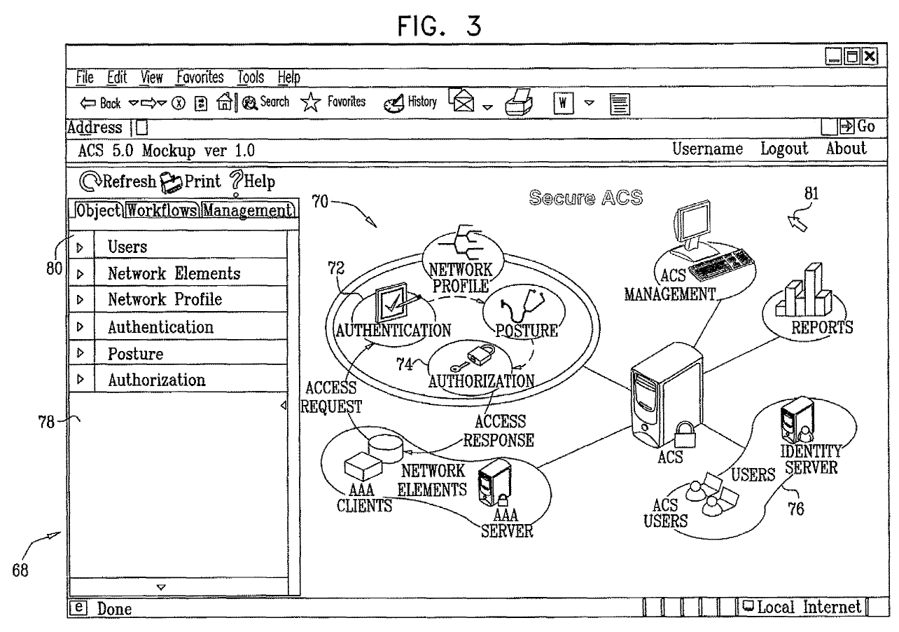

Reference is now made to FIG. 3, which is a screen display 68 including in its content area a typical graphical representation 70 of a network whose access is being managed, in accordance with a disclosed embodiment of the invention. The graphical representation 70 corresponds to step 52 (FIG. 2). In this example a high level view orients the user to different system functions and their interrelations, and indicates possibilities for configuring the system using the access control system management application. Among the functional elements represented in FIG. 3 are an authentication function icon 72, an authorization function icon 74 and a users icon 76. A navigation panel 78 at the left of the screen display 68 has entries corresponding to elements of the graphical representation 70, for example an entry 80 labeled “users”, which corresponds to the users icon 76. A mouse pointer 81 is present in an insignificant position within the content area of the screen display 68.

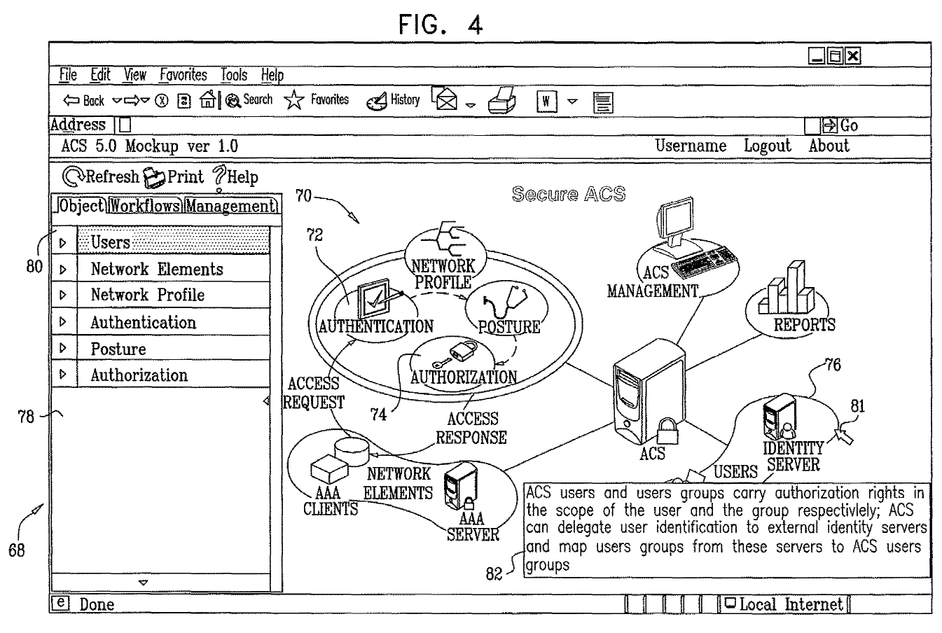

Reference is now made to FIG. 4, which shows another state of the screen display 68 (FIG. 3), in accordance with a disclosed embodiment of the invention. The pointer 81 was positioned generally over the users icon 76, thereby indicating the user function as a potential item of interest. Responsively to the position of the selection device, a context-sensitive help description 82 was superimposed on the graphical representation 70, generally in the area occupied by the users icon 76. Simultaneously, the entry 80 in the navigation panel was highlighted, The entry 80 is the menu drawer responsible for user configuration. The screen display 68, corresponding to step 54 (FIG. 2), is shown in a state in which the user was invited to confirm the tentative selection of the user function with the selection device, e.g., by a mouse click, on the users icon 76. This would result in a more detailed view, as described below. Alternatively, the entry 80 could have been selected with the selection device or with another conventional input device, such as a keyboard or touch screen, as attention was drawn by its emphasis on the screen. The same result is produced in either case.

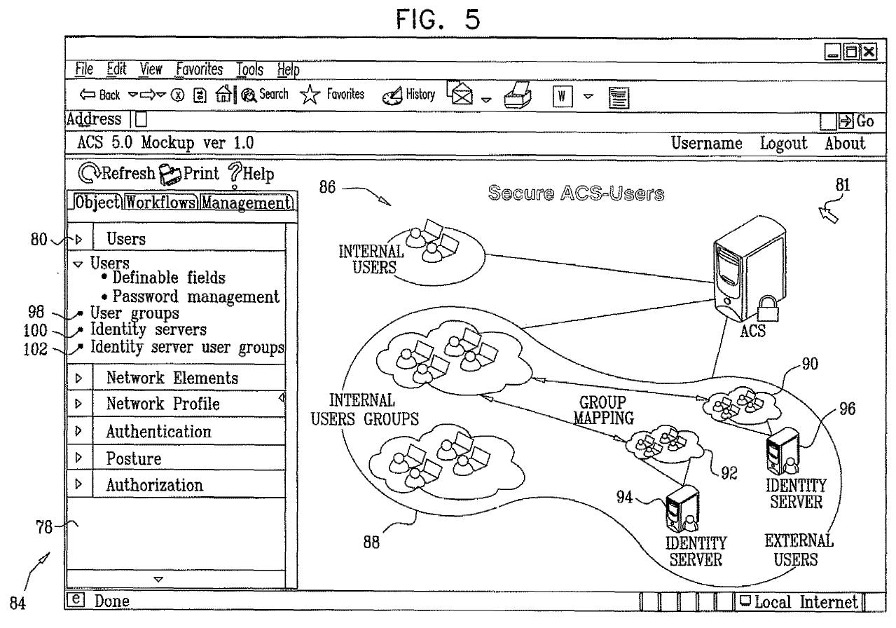

Reference is now made to FIG. 5, which shows a screen display 84, which includes a graphical representation 86 of user configuration domains, and which is a more detailed version of the user functions represented by the users icon 76 (FIG. 4) in accordance with a disclosed embodiment of the invention. This view corresponds to step 66 (FIG. 2). The graphical representation 86 includes an internal users groups icon 88, group mapping icons 90, 92, and identity server icons 94, 96. The entry 80 in the navigation panel 78 is now expanded to show a submenu. An entry 98, labeled “User groups” corresponds to the internal users groups icon 88, an entry 100, labeled “Identity servers” corresponds to the identity server icons 94, 96, and an entry 102, labeled “Identity server user groups mapping” corresponds to the group mapping icons 90, 92. The pointer 81 is again in an insignificant location in the content area of the screen display 84

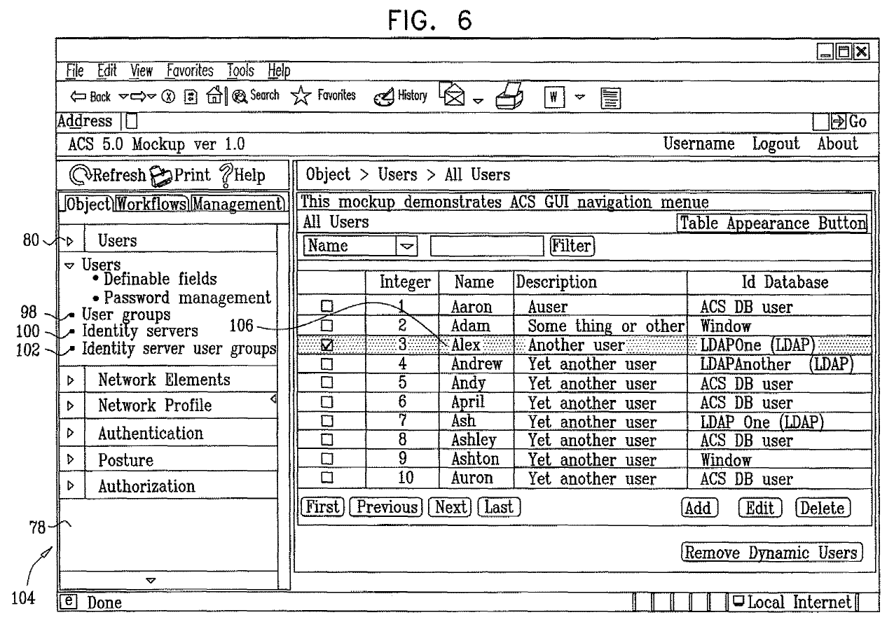

Reference is now made to FIG. 6, which shows another screen display 104 that was produced in accordance with a disclosed embodiment of the invention. This view corresponds to step 60 (FIG. 2). The appearance of the navigation panel 78 remains unchanged when compared to FIG. 5. However, the graphical representation 86 (FIG. 5) is no longer present. Instead, the content area comprises a list of ten users, from which a user 106 (Alex) has been selected. From this point operations respecting the user 106 were conducted conventionally.

### EMBODIMENT 2

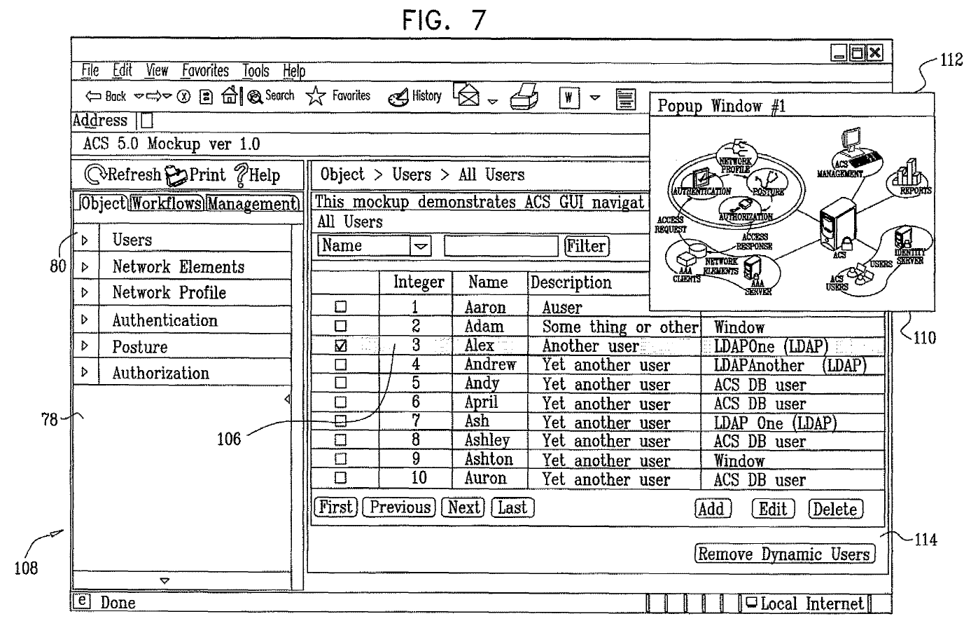

In another embodiment of the invention, the graphical representation does not occupy the content area, although it may be superimposed at least in part. Reference is now made to FIG. 7, which is a screen display 108 showing a graphical representation 110 of a network being managed, in accordance with an alternate embodiment of the invention. The graphical representation 110 displays the same information as the graphical representation 70 (FIG. 3), except that it occupies the content area of a popup window 112. The main display has a content area 114, which contains other content that may be of interest to the user. This embodiment has the advantage of displaying both a representation of a hierarchical system and content simultaneously, Of course, help information (not shown) may be also shown, e.g., as tool tips or additional popup windows.

### EMBODIMENT 3

Reducing the number of clicks to obtain frequently used operations can be achieved by adding shortcuts to the graphical representation. Such shortcuts are implemented as shortcut icons embedded in the graphical representation, preferably in the region of the graphical representation that relates to the desired operations.

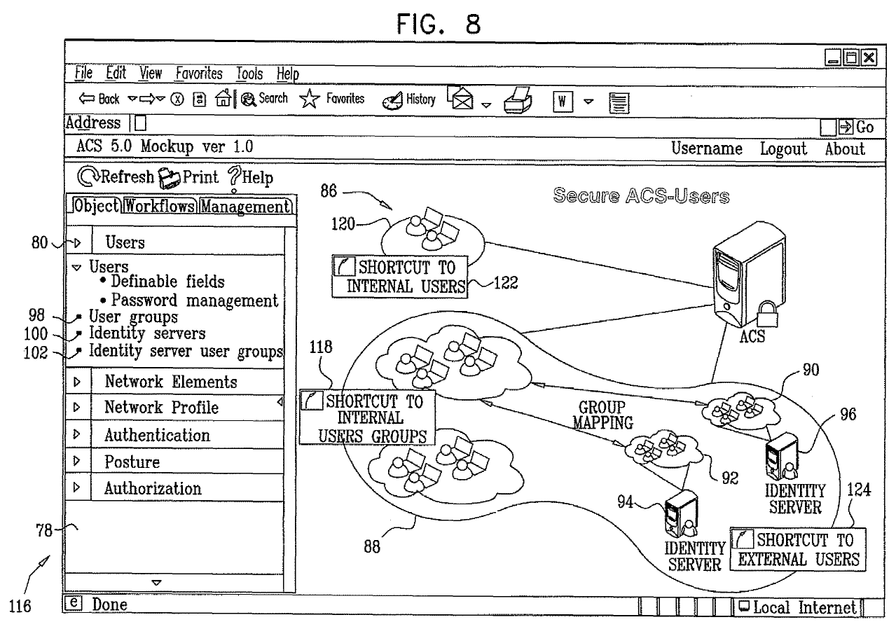

Reference is now made to FIG. 8, which is a screen display 116 similar to the screen display 84 (FIG. 5) in which some of the group icons have been augmented by shortcut icons in accordance with a disclosed embodiment of the invention. The internal users groups icon 88 now includes a shortcut icon 118. An internal users icon 120 includes a shortcut icon 122. A shortcut icon 124 directed to external users is now present. Applying a selection device, for example, to the internal users groups icon 88, has the same effect as described above with reference to FIG. 2. However, applying the selection device to one of the shortcut icons 118, 122, 124 causes the target of the shortcut to be selected. This is the same result as is obtained by selecting a menu item in the navigation panel 78.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A system for accessing hierarchically arranged information comprising:
a memory; and
a processing unit connectable to a display unit, and to a selection device having a visual indicator, said processing unit executing a computer program stored in said memory, wherein responsively to instructions of said computer program, said processing unit is operative for controlling said display unit to visually present thereon a hierarchical model of said information and a navigation panel having first and second controls, said hierarchical model comprising first and second icons arranged in respective first and second hierarchical levels, and respectively mapped to said first and second controls;
wherein responsively to a presence of said visual indicator proximate one of said first icons, a corresponding first control of said navigation panel is emphasized, and
wherein responsively to a selection of one of said first icons, said first icons are replaced by said second icons, and said navigation panel is modified to present said second controls on said display unit.

2. The system according to claim 1, wherein said second controls comprise submenus of said first controls, and exposure of said second controls on said navigation panel causes said first icons to be replaced by said second icons.

3. The system according to claim 1, responsively to said presence of said visual indicator proximate one of said first icons, said processing unit causes said display unit to present a help screen relating to said one first icon.

4. The system according to claim 1, wherein said first icons are presented in a content area of a screen on said display unit.

5. The system according to claim 1, wherein said first icons are presented in a popup window on said display unit.

6. The system according to claim 1, wherein said first icons comprises shortcut icons for selection of a data item.

7. A method for accessing hierarchically arranged information comprising:
executing a computer program, and responsively to instructions of said program, visually presenting a hierarchical model of said information comprising first and second icons arranged in respective first and second hierarchical levels, said icons representing data items, and a navigation panel having first and second controls respectively mapped to said first and second icons;
responsively to a presence of a visual indicator proximate one of said first icons, emphasizing a corresponding first control of said navigation panel; and
responsively to a selection of one of said first icons, replacing said first icons by said second icons, and modifying said navigation panel to visually present said second controls.

8. The method according to claim 7, wherein said second controls comprise submenus of said first controls, further comprising the steps of exposing said second controls on said navigation panel, and responsively replacing said first icons by said second icons.

9. The method according to claim 7, further comprising the step of responsively to said presence of said visual indicator proximate one of said first icons, presenting a help screen relating to said one first icon.

10. The method according to claim 7, wherein said first icons are presented in a content area of a screen display.

11. The method according to claim 7, wherein said first icons are visually presented in a popup window.

12. The method according to claim 7, wherein said first icons comprises shortcut icons for selection of one of said data items.

13. The method according to claim 7, further comprising the step of gathering said information through use of a network management protocol that remotely queries network devices of a computer network and, in turn, receives information from said network devices so as to respectively populate said first and second hierarchical levels with said gathered information.

14. A computer program product for accessing hierarchically arranged information, including a tangible computer-readable medium in which computer program instructions are stored, which instructions, when read by a computer, cause the computer to:
visually present a hierarchical model of said information comprising first and second icons arranged in respective first and second hierarchical levels, said icons representing data items, and a navigation panel having first and second controls respectively mapped to said first and second icons;
emphasize a corresponding first control of said navigation panel responsively to a presence of a visual indicator proximate one of said first icons,
modify said navigation panel to display said second controls responsively to a selection of one of said first icons and to replace said first icons by said second icons.

15. The computer program product according to claim 14, wherein said second controls comprise submenus of said first controls, wherein said computer is further instructed to expose said second controls on said navigation panel, and to replace said first icons by said second icons.

16. The computer program product according to claim 14, wherein said computer is further instructed to present a help screen relating to said one first icon responsively to said presence of said visual indicator proximate one of said first icons.

17. The computer program product according to claim 14, wherein said first icons are visually presented in a content area of a screen display.

18. The computer program product according to claim 14, wherein said first icons are presented in a popup window of a screen display.

19. The computer program product according to claim 14, wherein said first icons comprises shortcut icons for selection of one of said data items.

20. The computer program product according to claim 14, wherein said computer is further instructed to gather said information through use of a network management protocol that remotely queries network devices of a computer network and, in turn, receives said information from said network devices so as to respectively populate said first and second hierarchical levels with said information.

21. A management apparatus for management of a computer network comprising:
processor means for executing a computer program for managing said computer network, said processor means coupled to said computer network and operative for displaying information from network devices in at least first and second hierarchical levels in a hierarchical model of said computer network with respective first and second data items relating to said network devices;
display means responsive to said processor means, for visually presenting simultaneously a first graphical presentation of said first data items and a navigation panel having first controls mapped and coordinated with corresponding elements of said first graphical presentation for selection of said first data items; and
responsively to user selection of one of said first data items on said first graphical presentation, said display means is operative for replacing said first graphical presentation by a second graphical presentation of said second data items, and modifying said navigation panel to show second controls for selection of said second data items.
